(19) United States
(12) Patent Application Publication
(10) Pub. No.: US 2020/0118163 A1
(43) Pub. Date: Apr. 16, 2020

(54) METHOD AND SYSTEM FOR DETECTION OF ADVERTISEMENT FRAUD

(71) Applicant: Affle (India) Limited, Mumbai City (IN)

(72) Inventors: Anuj Khanna SOHUM, Singapore (SG); Charles Yong Jien FOONG, Singapore (SG); Madhusudana RAMAKRISHNA, Singapore (SG)

(73) Assignee: Affle (India) Limited, Mumbai City (IN)

(21) Appl. No.: 16/653,863

(22) Filed: Oct. 15, 2019

(30) Foreign Application Priority Data
Oct. 15, 2018 (IN) 201821039075

(51) Int. Cl. G06Q 30/02; G06Q 30/00; G06N 3/08

(52) U.S. Cl. CPC G06Q 30/0248; G06Q 30/0255; G06N 3/08; G06Q 30/0185; G06Q 30/0261

(57) ABSTRACT

The present disclosure provides a method and system for detection of advertisement fraud in one or more advertisements. The system receives and analyzes a user data, and a user action data in real-time. In addition, the system detects one or more fraudulent actions in real-time. The one or more fraudulent actions are detected based on deviation in the user data and the user action data from a predefined user data and a predefined user action data respectively. Further, the system inserts a set of advertisements along with the one or more advertisements in real-time. Furthermore, the system sends one or more notifications for alerting an advertiser.

### TECHNICAL FIELD

The present disclosure relates to the field of fraud detection systems and, in particular, relates to a method and system for detection of advertisement fraud.

### INTRODUCTION

With the advancements in technology over the last few years, users have predominantly shifted towards smartphones for accessing multimedia content. Nowadays, users access content through a number of applications available for download through various online application stores. Businesses (Advertisers) have started focusing on generating revenue by targeting consumers through these applications. In addition, businesses have started investing heavily in doing business with these applications. Moreover, businesses (publishers and/or advertising networks) have started developing capable advertisement applications for serving advertisements through these applications. These advertisements are published in real time or fixed placements through these applications and watched by the users. The advertisers are benefited in terms of internet traffic generated by clicking, taking action like installing or on watching these advertisements. However, certain online publishers and advertising networks working with these publishers take undue advantage of this in order to generate high revenues. These online publishers and advertising networks employ fraudulent techniques in order to generate clicks or to increase actions like increasing number of application install for the advertisers through fraudulent means. In addition, these online publishers incentivize the users for clicking on links, downloading applications and the like. This results in a loss of advertisers marketing budget spent as many times these publishers claim a normal user-initiated action (Organic action, e.g. Organic Install) as one initiated by them or at times the clicks or application installs are not driven by humans at all and instead by bots. There is a consistent need to stop publishers from performing such types of click fraud and transaction fraud.

### SUMMARY

In a first example, a computer-implemented method is provided. The computer-implemented method is configured for detecting advertisement fraud occurring using one or more sources in real-time. The method includes a first step of receiving a user data and a user action data in real-time at an advertisement fraud detection system. The method includes another step of analyzing the user data and the user action data in real-time at the advertisement fraud detection system. The method includes yet another step of detecting one or more fraudulent actions in real-time at the advertisement fraud detection system. The method includes yet another step of inserting a set of advertisements along with one or more advertisements in real-time at the advertisement fraud detection system. The method includes yet another step of sending one or more notifications for alerting an advertiser at the advertisement fraud detection system. The user data and the user action data is received from a media device associated with a user. The user data includes data associated with demographic information of the user. The user action data includes data associated with actions performed by the user using the media device and interaction of the user with the one or more advertisements. The user data and the user action data is analyzed with facilitation of one or more hardware-run algorithms. The one or more fraudulent actions are detected based on deviation in the user data and the user action data from a predefined user data and a predefined user action data respectively. The set of advertisements are fake advertisements inserted to attract the one or more sources for performing the advertisement fraud. The set of advertisements are inserted in one or more formats. The set of advertisements are inserted for confirming the one or more fraudulent actions performed by the one or more sources for conducting the advertisement fraud. The one or more notifications are sent to the advertiser with facilitation of one or more mediums. The one or more notifications are sent based on the one or more fraudulent actions performed using the one or more sources.

In an embodiment of the present disclosure, the user data includes name, location, IP address, age, gender, culture, religion, marital status, nationality, education level and demographic information of the user. The user action data includes number of clicks, number of impressions, one or more transactions, one or more purchases, number of advertisements, and user behavior.

In an embodiment of the present disclosure, the one or more sources includes at least one of malicious websites, an internet bot, web bot program, viruses, robots, and web crawlers.

In an embodiment of the present disclosure, the set of advertisements includes honeypot based advertisement campaign, zero pixel advertisements, blurred advertisements, content based advertisements, and non-human clickable advertisements.

In an embodiment of the present disclosure, the one or more formats includes at least one of display ads, social media ads, video ads, email ads, text advertisement, audio advertisements, and graphical advertisements.

In an embodiment of the present disclosure, the one or more hardware-run algorithms include at least one of machine learning algorithms, artificial intelligence algorithms, neural network algorithms, and deep learning algorithms.

In an embodiment of the present disclosure, the one or more fraudulent actions include number of fraud clicks, fraudulent location, number of fake conversation, fraudulent behavior, fraudulent device, and fraudulent IP address.

In an embodiment of the present disclosure, the one or more mediums include text message, email, voice notification, voice call, flash message, notification, mms and OTA messages.

In yet another embodiment of the present disclosure, the advertisement fraud detection system maps the user data with the predefined user data and the user action data with the predefined user action data. The mapping is performed for detecting deviation in the user data from the predefined user data and deviation in the user action data from the predefined user action data. The mapping is performed for detecting the advertisement fraud performed by the fraudulent publishers.

In an embodiment of the present disclosure, the advertisement fraud detection system blocks the one or more sources. The advertisement fraud detection system blocks the one or more sources in real time, wherein the advertisement fraud detection system blocks the one or more sources based on one or more fraudulent actions.

In a second example, a computer system is provided. The computer system includes one or more processors and a memory. The memory is coupled to the one or more processors. The memory stores instructions. The instructions are executed by the one or more processors. The execution of instructions causes the one or more processors to perform a method for detecting advertisement fraud occurring using one or more sources in real-time. The method includes a first step of receiving a user data, and a user action data in real-time at an advertisement fraud detection system. The method includes another step of analyzing the user data and the user action data in real-time at the advertisement fraud detection system. The method includes yet another step of detecting one or more fraudulent actions in real-time at the advertisement fraud detection system. The method includes yet another step of inserting a set of advertisements along with one or more advertisements in real-time at the advertisement fraud detection system. The method includes yet another step of sending one or more notifications for alerting an advertiser at the advertisement fraud detection system. The user data and the user action data is received from a media device associated with a user. The user data includes data associated with demographic information of the user. The user action data includes data associated with actions performed by the user using the media device and interaction of the user with the one or more advertisements. The user data and the user action data is analyzed with facilitation of one or more hardware-run algorithms. The one or more fraudulent actions are detected based on deviation in the user data and the user action data from a predefined user data and a predefined user action data respectively. The set of advertisements are fake advertisements inserted to attract the one or more sources for performing the advertisement fraud. The set of advertisements are inserted in one or more formats. The set of advertisements are inserted for confirming the one or more fraudulent actions performed by the one or more sources for conducting the advertisement fraud. The one or more notifications are sent to the advertiser with facilitation of one or more mediums. The one or more notifications are sent based on the one or more fraudulent actions performed using the one or more sources.

In a third example, a non-transitory computer-readable storage medium is provided. The computer executable instructions that, when executed by at least one processor, performs a method. The method is configured for detecting advertisement fraud occurring using one or more sources in real-time. The method includes a first step of receiving a user data, and a user action data in real-time at an advertisement fraud detection system. The method includes another step of analyzing the user data and the user action data in real-time at the advertisement fraud detection system. The method includes yet another step of detecting one or more fraudulent actions in real-time at the advertisement fraud detection system. The method includes yet another step of inserting a set of advertisements along with one or more advertisements in real-time at the advertisement fraud detection system. The method includes yet another step of sending one or more notifications for alerting an advertiser at the advertisement fraud detection system. The user data and the user action data is received from a media device associated with a user. The user data includes data associated with demographic information of the user. The user action data includes data associated with actions performed by the user using the media device and interaction of the user with the one or more advertisements. The user data and the user action data is analyzed with facilitation of one or more hardware-run algorithms. The one or more fraudulent actions are detected based on deviation in the user data and the user action data from a predefined user data and a predefined user action data respectively. The set of advertisements are fake advertisements inserted to attract the one or more sources for performing the advertisement fraud. The set of advertisements are inserted in one or more formats. The set of advertisements are inserted for confirming the one or more fraudulent actions performed by the one or more sources for conducting the advertisement fraud. The one or more notifications are sent to the advertiser with facilitation of one or more mediums. The one or more notifications are sent based on the one or more fraudulent actions performed using the one or more sources.

### BRIEF DESCRIPTION OF DRAWINGS

Having thus described the invention in general terms, references will now be made to the accompanying figures, wherein:

FIG. 1 illustrates an interactive computing environment for detection of advertisement fraud occurring from one or more sources in real-time, in accordance with various embodiments of the present disclosure; and

FIG. 2 illustrates a flowchart of a method for the detection of the advertisement fraud occurring from the one or more sources in real-time, in accordance with various embodiments of the present disclosure; and

FIG. 3 illustrates a block diagram of a computing device, in accordance with various embodiments of the present disclosure.

It should be noted that the accompanying figures are intended to present illustrations of exemplary embodiments of the present disclosure. These figures are not intended to limit the scope of the present disclosure. It should also be noted that accompanying figures are not necessarily drawn to scale.

### DETAILED DESCRIPTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Moreover, although the following description contains many specifics for the purposes of illustration, anyone skilled in the art will appreciate that many variations and/or alterations to said details are within the scope of the present technology. Similarly, although many of the features of the present technology are described in terms of each other, or in conjunction with each other, one skilled in the art will appreciate that many of these features can be provided independently of other features. Accordingly, this description of the present technology is set forth without any loss of generality to, and without imposing limitations upon, the present technology.

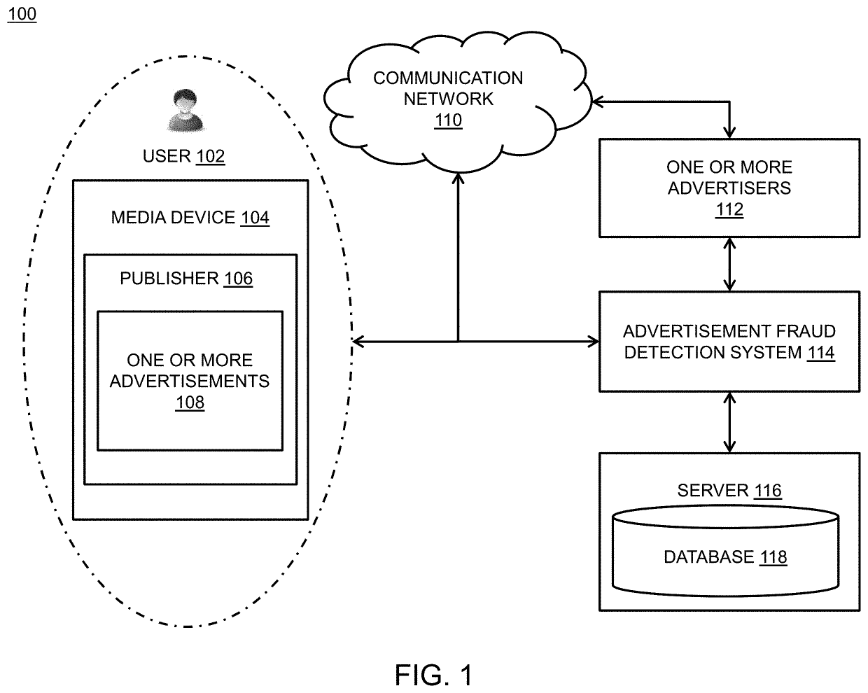

FIG. 1 illustrates an interactive computing environment 100 for detection of advertisement fraud occurring from one or more sources in real-time, in accordance with various embodiments of the present disclosure. In general, advertisement fraud is concerned with theory and practice of fraudulently representing online advertisement impressions, clicks, conversion or data events in order to generate revenue. The interactive computing environment 100 includes a user 102, a media device 104, a publisher 106 and one or more advertisements 108. In addition, the interactive computing environment 100 includes a communication network 110, one or more advertisers 112, an advertisement fraud detection system 114, a server 116 and a database 118.

The interactive computing environment 100 includes the user 102. The user 102 is a person who accesses online multimedia content. The user 102 is an individual that requires an IP based network for accessing the online multimedia content. In an embodiment of the present disclosure, the user 102 is a computer or bot. In another embodiment of the present disclosure, the user 102 includes but may not be limited to a natural person, legal entity, individual, automated machine and robot. In general, automated machine or robot is programmed to perform a task on its own. The user 102 utilizes the media device 104 to access the online multimedia content. The user 102 is a person that accesses the media device 104 to view the one or more advertisements 108. The user 102 is a person that clicks on the one or more advertisements 108 in order to know more about product, business, or service offered by the one or more advertisements 108. The user 102 is a person that accesses the one or more advertisements 108 through the media device 104.

The interactive computing environment 100 includes the media device 104. The media device 104 is associated with the user 102. In an embodiment of the present disclosure, the media device 104 is used to display the online multimedia content to the user 102. In an embodiment of the present disclosure, the online multimedia content includes the one or more advertisements 108. In addition, the media device 104 is used to view an application installed on the media device 104. In general, media device is an equipment or device capable of transmitting analog or digital signals through communication wire or remote way. The media device 104 includes but may not be limited to smartphone, laptop, personal computer, tablet, smart watch, gesture-controlled devices and personal digital assistant. In an embodiment of the present disclosure, the media device 104 includes smart television, workstation, an electronic wearable device and the like. In addition, the media device 104 is connected to an active internet connection. In an embodiment of the present disclosure, the media device 104 is used to view multimedia content on the publisher 106. In an embodiment of the present disclosure, the user 102 access the media device 104 while moving from one place to another. In an example, place includes home, park, restaurant, any facility, college, university, office and the like.

The interactive computing environment 100 includes the publisher 106. The publisher 106 is an application which is used to view the online multimedia content on the media device 104 to the user 102. The online multimedia content includes at least one of text content, video content, audio content, graphical content and the like. In an embodiment of the present disclosure, the publisher 106 is installed on each of the media device 104. The publisher 106 includes but may not be limited to mobile application, web application, web browser and website. In an embodiment of the present disclosure, the publisher 106 displays the online multimedia content related to interest of the user 102. In an example, the user 102 may be interested in watching online videos, reading blogs, playing online games, accessing shopping websites, accessing social networking sites and the like.

In yet another embodiment of the present disclosure, the publisher 106 may be advertisement supporting applications which are installed on the media device 104. The publisher 106 includes but may not be limited to the advertisement supporting applications such as gaming applications, utility applications and service based applications. The publisher 106 provides space, frame, area or a part of application pages for advertising purposes. The space, frame, area or a part of application pages are referred to as advertisement slots. The publisher 106 has various advertisement slots. The publisher 106 advertises products, services or businesses to the user 102 for generating revenue. The publisher 106 displays the one or more advertisements 108 on the media device 104 when the user 102 accesses the publisher 106.

The interactive computing environment 100 includes the one or more advertisements 108. The one or more advertisements 108 are an audio or visual form of marketing communication to promote or sell any product, service or business. In an embodiment of the present disclosure, the one or more advertisements 108 are a graphical or pictorial representation of information in order to promote any product, an event, service and the like. The one or more advertisements 108 include at least one of display ads, social media ads, video ads, email ads, text advertisement, audio advertisements, graphical advertisements and the like. In an embodiment of the present disclosure, the one or more advertisements 108 are displayed in third party applications developed by the publisher 106. The one or more advertisements 108 are displayed on the media device 104 to attract the user 102 in order to generate revenue. The one or more advertisements 108 are genuine advertisements that are clicked by the user 102 on the media device 104 to generate revenue for the advertiser. In an example, the one or more advertisements 108 include advertisement of a biscuit company coming on Youtube before start of the intended video the user 102 clicked on. In yet another example, the one or more advertisements 108 include advertisement of shampoo brand coming up in between a Facebook video being viewed by the user 102.

In an embodiment of the present disclosure, the one or more advertisements 108 are advertisement campaigns which are executed by the publisher 106. The one or more advertisements 108 are provided to the publisher 106 by the one or more advertisers 112. In general, a campaign is a planned set of activities that is carried out over a period of time in order to achieve a certain goal. In addition, advertisement campaigns are campaigns that are targeted to certain number of users in order to achieve a set of goals.

In an embodiment of the present disclosure, the one or more advertisements 108 are displayed to the user 102 based on interest of the user 102. The user 102 may or may not click on the one or more advertisements 108. The user 102 is redirected to website or application upon clicking on the one or more advertisements 108. In an embodiment of the present disclosure, the user 102 is redirected to a store for installing application upon clicking on the one or more advertisements 108. In an example, the store includes but may not be limited to online stores, application store, third party store, web store, apple store and playstore. The one or more advertisements 108 are provided to the publisher 106 by the one or more advertisers 112 who want to advertise their product through the publisher 106. In addition, the publisher 106 gets paid or rewarded if the user 102 visits the website or the application through the one or more advertisements 108.

The interactive computing environment 100 includes the communication network 110. The communication network 110 denotes channels of communication (networks by which information flows). In an embodiment of the present disclosure, the communication network 110 includes LAN, MAN, WAN, and the like. In general, local area network, or LAN, cable or fiber, is used to connect computer equipment and other terminals distributed in the local area, such as in the university campus. In addition, Metropolitan Area Network or MAN is a high-speed network that is used to connect a small geographical area such as a LAN across the city. Further, Wide area networks, or any communication connections, including WAN, microwave radio link and satellite, are used to connect computers and other terminals to a larger geographic distance.

In an embodiment of the present disclosure, the communication network 110 may be any type of network that provides internet connectivity to the advertisement fraud detection system 114. In another embodiment of the present disclosure, the communication network 110 may be any type of network that provides internet connectivity to the media device 104. In an embodiment of the present disclosure, the communication network 110 is a wireless mobile network. In another embodiment of the present disclosure, the communication network 110 is a wired network with finite bandwidth. In yet another embodiment of the present disclosure, the communication network 110 is a combination of the wireless and the wired network for optimum throughput of data transmission. In yet another embodiment of the present disclosure, the communication network 110 is an optical fiber high bandwidth network that enables high data rate with negligible connection drops. In yet another embodiment of the present disclosure, the communication network 110 provides medium to the media device 104 to connect to the advertisement fraud detection system 114. In this scenario, the communication network 110 may be a global network of computing devices such as the Internet. The communication network 110 provides network connectivity to elements of the interactive computing environment 100.

The interactive computing environment 100 includes the one or more advertisers 112. The one or more advertisers 112 may be a person, an organization, a group of persons or a company who wants to advertise their product, service, business and the like. The one or more advertisers 112 approach the publisher 106 and provide the one or more advertisements 108 to be displayed on the publisher 106. The one or more advertisers 112 pay or rewards the publisher 106 based on number of clicks of number of users redirected to the product, the service or the business of the one or more advertisers 112. In an embodiment of the present disclosure, the one or more advertisers 112 pay or rewards the publisher 106 based on number of users who download the application. Moreover, the application is downloaded from the store after clicking on the one or more advertisements 108. The publisher 106 wants more and more number of users to click on the one or more advertisements 108 in order to generate a high amount of revenue.

The one or more advertisements 108 are placed in advertisement slots of the publisher 106 on the media device 104. The one or more advertisers 112 purchase the advertisement slots from the publisher 106. The one or more advertisements 108 are served based on a real-time bidding technique or a direct contract between the one or more advertisers 112 and the publisher 106. The one or more advertisers 112 provide the one or more advertisements 108 to advertising networks and information associated with the advertisement campaigns. The advertisement networks enable display of the one or more advertisements 108 on the publisher 106 on behalf of one or more advertisers 112 in real-time. The advertising networks are entities that connect the one or more advertisers 112 to the publisher 106 or the applications that are willing to serve the one or more advertisements 108.

The interactive computing environment 100 includes the advertisement fraud detection system 114. The advertisement fraud detection system 114 is associated with the publisher 106 and the one or more advertisers 112. The advertisement fraud detection system 114 detects advertisement fraud in the one or more advertisements 108 in the online multimedia content and may block fraudulent advertising traffic. The advertisement fraud detection system 114 detects the advertisement fraud occurring through one or more sources in real-time. The one or more sources include but may not be limited to malicious websites, an internet bot, web bot program, viruses, robots, and web crawlers. In an embodiment of the present disclosure, the one or more sources are implemented by the publisher 106 in order to generate more revenue based on more number of clicks on the one or more advertisements 108. In addition, the advertisement fraud detection system 114 blocks the one or more sources that perform activities such as click spamming to simulate fake traffic. In an embodiment of the present disclosure, the advertisement fraud detection system 114 blocks the publisher 106 that implements fraudulent methods such as the one or more sources to simulate fake traffic. Further, the advertisement fraud detection system 114 alerts the one or more advertisers 112 about the publisher 106 or the one or more sources that simulate fake traffic in real time.

The advertisement fraud detection system 114 receives a user data and a user action data in real-time. The advertisement fraud detection system 114 receives the user data and the user action data from the media device 104 associated with the user 102. The user data includes data associated with demographic information of the user 102. The user data includes name of the user 102, location of the user 102, IP address of the user 102, age of the user 102, gender of the user 102, culture of the user 102, religion of the user 102, marital status of the user 102, nationality of the user 102, education level of the user 102 and demographic information of the user 102. The user data provides complete information of the user 102 that helps in detection of the user 102. Further, the user action data includes data associated with actions performed by the user 102 using the media device 104. Furthermore, the user action data includes data of interaction of the user 102 with the one or more advertisements 108. The user action data includes but may not be limited to number of clicks, number of impressions, one or more transactions, one or more purchases, number of advertisements, and user behavior. In an example, the advertisement fraud detection system 114 receives the demographic information of the user 102. The demographic information includes age, gender, culture, ethnicity, religion, educational level and the like. The demographic information is received in real time.

In an example, the user action data includes number of clicks made by the user 102 on the one or more advertisements 108. In another example, the user action data includes data of purchases of an application, in-application purchases and the like made by the user 102. In yet another example, the user action data includes data of number of advertisements being displayed to the user 102 in a particular interval of time (say, 1 hour).

In an embodiment of the present disclosure, the advertisement fraud detection system 114 receives traffic data initiated through the media device 104 of the user 102. The traffic data is generated when the one or more advertisements 108 are viewed on the publisher 106 through the media device 104. The traffic data is generated when the one or more advertisements 108 are clicked by the user 102. In general, traffic data includes list of users who have clicked on the one or more advertisements 108 of the one or more advertisers 112. In addition, the advertisement fraud detection system 114 may perform detection of the advertisement fraud in the one or more advertisements 108 in real time.

In another embodiment of the present disclosure, the advertisement fraud detection system 114 receives device data of the media device 104 associated with the user 102 in real time. The device data includes number of application installs, data from a plurality of sensors, location of each of the media device 104 and the like. The plurality of sensors includes but may not be limited to gyroscope, accelerometer, magnetometer, and proximity sensor.

The advertisement fraud detection system 114 analyzes the user data and the user action data in real-time. The advertisement fraud detection system 114 analyzes the user data and the user action data to detect the potential advertisement fraud occurring using the one or more sources. The advertisement fraud detection system 114 analyzes the user data and the user action data with facilitation of one or more hardware-run algorithms. The one or more hardware-run algorithms include at least one of machine learning algorithms, artificial intelligence algorithms, neural network algorithms, and deep learning algorithms.

The advertisement fraud detection system 114 detects one or more fraudulent actions in real-time. In an embodiment of the present disclosure, the one or more fraudulent actions are performed by the one or more sources. In another embodiment of the present disclosure, the one or more fraudulent actions are performed by the publisher 106.

The one or more fraudulent actions are detected based on deviation in the user data and the user action data from a predefined user data and a predefined user action data. The one or more fraudulent actions includes but may not be limited to number of fraud clicks, fraudulent location, number of fake conversation, fraudulent behavior, fraudulent device, and fraudulent IP address.

The advertisement fraud detection system 114 maps the user data with the predefined user data and the user action data with the predefined user action data. The advertisement fraud detection system 114 performs the mapping to detect deviation in the user data from the predefined user data and deviation in the user action data from the predefined user action data. The mapping is performed to detect the advertisement fraud performed by the fraudulent publisher 106.

In an embodiment of the present disclosure, the advertisement fraud detection system 114 identifies behavior of the user 102. The identification of the behavior of the user 102 is done based on the device data, the traffic data and the third party data collected from third party databases. The identification of the behavior of the user 102 is done in order to identify if the user 102 or the publisher 106 is committing the advertisement fraud in the one or more advertisements 108.

In another embodiment of the present disclosure, the advertisement fraud detection system 114 analyzes the user behavior, the device data, and the traffic data. The analysis is done in order to identify if the user 102 or the publisher 106 is fraud or genuine. In general, genuine user of the user 102 or the publisher 106 is not employing the bots or the automated machines to generate traffic on the one or more advertisements 108. The analysis is done by using machine learning algorithms. In another embodiment of the present disclosure, the advertisement fraud detection system 114 may use any other algorithm to perform analysis of the user behavior.

In an embodiment of the present disclosure, the advertisement fraud detection system 114 identifies behavior of the user 102 based on user routine. In an example, the advertisement fraud detection system 114 may take into account a time of the day when the user 102 is most active. Moreover, the advertisement fraud detection system 114 identifies behavior of the user 102 through application data. The application data includes but may not be limited to application usage time, and application idle time. Also, the advertisement fraud detection system 114 examines the behavior of the user 102 to identify a downtime. Also, the advertisement fraud detection system 114 analyzes the number of clicks on the one or more advertisements 108 with a predefined threshold. In general, downtime is the time during which a user is inactive or not using the application. In addition, the downtime is the time during which there is less traffic on the number of clicks done by the user 102. In an example, the user 102 is inactive during early morning hours. This results in lesser number of clicks as the user 102 is inactive during the early morning hours. The advertisement fraud detection system 114 detects that the clicks are done by the bots or the automated machines if the number of clicks occurring during the early morning hours are more than the predefined threshold. In an embodiment of the present disclosure, the predefined threshold is entered by the one or more advertisers 112. In another embodiment of the present disclosure, the predefined threshold is identified by the advertisement fraud detection system 114 based on the analysis of the third party data or the user behavior.

In another embodiment of the present disclosure, the advertisement fraud detection system 114 inserts a random captcha or re-captcha as part of installation to detect fraud. In general, captcha is a computer program intended to distinguish human from machine input. The captcha is used to protect websites from machine generated attacks. In addition, the captcha is type of challenge-response test used in computing to verify that the user 102 is human. The captcha shows random string which is easy for humans to solve but hard for bots or computers to decode. In an embodiment of the present disclosure, the captcha may be of various types. The various types of the captcha includes standard distorted word, an audio captcha, picture captcha, math solving captcha, 3-D captcha and the like. In general, recaptcha is an improved version of captcha. In addition, the recaptcha uses an advanced risk analysis engine and adaptive captchas to keep automated software from engaging in abusive activities on the website.

In an embodiment of the present disclosure, the advertisement fraud detection system 114 uses machine learning algorithms to detect the advertisement fraud in the one or more advertisements 108. In another embodiment of the present disclosure, the advertisement fraud detection system 114 detects the advertisement fraud in the one or more advertisements 108 through gesture tracking. In general, gesture tracking is a technology that interprets human gestures through mathematical algorithms.

In another embodiment of the present disclosure, the advertisement fraud detection system 114 detects the advertisement fraud in the one or more advertisements 108 through eye-tracking. The advertisement fraud detection system 114 scans retina of an eye of the user 102 and identifies whether the user 102 is human or robot. In addition, the advertisement fraud detection system 114 focuses on accurate tracking of human eye. Further, the advertisement fraud detection system 114 monitors touch or click events with different eye movements.

In yet another embodiment of the present disclosure, the advertisement fraud detection system 114 detects the advertisement fraud in the one or more advertisements 108 through embedded implants. The advertisement fraud detection system 114 detects the advertisement fraud by identification of embedded implants in fingers or nails of the user 102. In an example, the embedded implant in fingers includes but may not be limited to electrical components that allow motion of fingers.

In an embodiment of the present disclosure, the advertisement fraud detection system 114 is integrated with the third party databases to receive information of the user 102. The third party databases are external source that does not have direct relationship with the user 102. The advertisement fraud detection system 114 receives third party data in real-time. The third party data includes the demographic information and the location information of the user 102. In an example, the third party databases include Facebook, Instagram, LinkedIn, Snapchat, Gmail, E-commerce websites and the like.

Further, the advertisement fraud detection system 114 inserts a set of advertisements along with the one or more advertisements 108 to confirm the advertisement fraud in real-time. The set of advertisements include at least one of honeypot based advertisement campaign, zero pixel advertisements, blurred advertisements, content based advertisements, non-human clickable advertisements, and the like. The set of advertisements are fake advertisements inserted to attract the one or more sources to perform the advertisement fraud. In an embodiment of the present disclosure, the publisher 106 performs the advertisement fraud to generate more revenue. In addition, the publisher 106 conducts the advertisement fraud with facilitation of the one or more sources.

In an embodiment of the present disclosure, the advertisement fraud detection system 114 inserts the honeypot based advertisement campaign along with the one or more advertisements 108. The honeypot based advertisement campaign is high rewarding campaign used to attract the user 102 to conduct the advertisement fraud in the one or more advertisements 108. In addition, the honeypot based advertisement campaign is used to confirm the advertisement fraud in the one or more advertisements 108 without use of any specialized tools. In an example, the set of advertisements show a reward of $5 for installation of the application playing Bengali radio is displayed in language A of country X. The one or more advertisements 108 in language A is displayed to the user 102 on the media device 104 residing in country Y. The user 102 in the country Y is not likely to click on the one or more advertisements 108 because language of country X is unknown to them. The advertisement fraud detection system 114 confirms presence of the bots or the one or more sources based on the clicks on the set of advertisements along with the one or more advertisements 108. In addition, the advertisement fraud detection system 114 blocks the bots or the one or more sources after detection in real-time.

In another embodiment of the present disclosure, the advertisement fraud detection system 114 inserts the zero pixel advertisements along with the one or more advertisements 108. The zero pixel advertisements is a campaign in which the set of advertisements are zero pixel advertisements. In general, zero pixel advertisements are zero pixel advertisements of 0*0 pixels. The zero pixel advertisements are displayed on the media device 104 associated with the user 102. In general, zero pixel advertisements are not identified by humans. The zero pixel advertisements are only identified by the bots or the automated machines. The advertisement fraud detection system 114 confirms that the one or more sources (say bot or automated machine) are performing the advertisement fraud based on clicks on the zero pixel advertisements as zero pixel advertisements are not identifiable by the user 102.

In yet another embodiment of the present disclosure, the advertisement fraud detection system 114 inserts the blurred advertisements along with the one or more advertisements 108. The blurred advertisements are unclear or foggy advertisements that would not display content of the advertisements properly. In an example, the user 102 (say who is genuine user) must not click on the blurred advertisements as the user 102 must be unable to read content of the advertisement. However, the bots or automated robots may click even on the blurred advertisements to generate more revenue for the publisher 106. The advertisement fraud detection system 114 confirms the advertisement fraud based on detection of user interactions with the blurred advertisements.

In yet another embodiment of the present disclosure, the advertisement fraud detection system 114 inserts the content based advertisements. In an embodiment of the present disclosure, content may be particular to a specific country, gender, interest, political opinion, age group, religion and the like. In an example, a user A resides in country India. There is minimum probability that the user A clicks on advertisements that offer products or services served in country Africa. The advertisement fraud detection system 114 inserts the content based advertisement offering products and services of country Africa to the user A of country India. The advertisement fraud detection system 114 detects and confirms the advertisement fraud if the user A constantly clicks the advertisement or visits web pages offering content for people of Africa.

In another example, the advertisement fraud detection system 114 receives the user data of a user ABC and identifies that the user ABC is a female. The advertisement fraud detection system 114 inserts advertisements related to male products (such as men face wash, beard oil, shaving cream) as the set of advertisements. If the advertisement fraud detection system 114 receives constant traffic from the user ABC on such advertisements, the advertisement fraud detection system 114 confirms the advertisement fraud being performed by the one or more sources.

In yet another example, the advertisement fraud detection system 114 creates a Facebook or Instagram profile that is kept empty with 0 number of posts. In addition, the Facebook or Instagram profile clearly says description such as “The page is completely empty for testing purposes. Kindly do not like it”. The genuine user is not going to hit like on the profiles after reading the description. However, if an automated bot or robot come across the profile, it is surely going to like the profile without going through the description of the profile just to create more revenue. The advertisement fraud detection system 114 confirms the advertisement fraud in such a manner.

The advertisement fraud detection system 114 blocks one or more fraudsters that are committing the advertisement fraud. In an embodiment of the present disclosure, the one or more fraudsters are the one or more sources conducting the advertisement fraud. In an embodiment of the present disclosure, the advertisement fraud detection system 114 blocks the user 102 or the publisher 106 if they are committing the advertisement fraud. The advertisement fraud detection system 114 blocks the one or more fraudsters based on the one or more fraudulent actions. The advertisement fraud detection system 114 performs blocking based on segregation in real time. In another embodiment of the present disclosure, the advertisement fraud detection system 114 performs blocking based on analysis of the traffic data in real time. In an embodiment of the present disclosure, the advertisement fraud detection system 114 segregates the user 102 or the publisher 106 based on the detection in real time. The segregation is done in order to separate fraudulent user of the user 102 or the publisher 106 in real time.

In an embodiment of the present disclosure, the advertisement fraud detection system 114 detects the advertisement fraud in the one or more advertisements 108 through demographic information of the user 102. The advertisement fraud detection system 114 analyzes the demographic information with the device data and the traffic data of the user 102 in order to detect the advertisement fraud. In an embodiment of the present disclosure, the analysis is done by using supervised or unsupervised machine learning algorithms. In another embodiment of the present disclosure, the advertisement fraud detection system 114 may use any other algorithms (say deep learning or neural network) to detect the advertisement fraud in the one or more advertisements 108.

In another embodiment of the present disclosure, the advertisement fraud detection system 114 detects the advertisement fraud in the one or more advertisements 108 through location information received through the media device 104 of the user 102. The location information refers to information based on location of the user 102. In an example, a user X lives in country A. If an advertisement of a general store which is situated in country B is displayed to the user X, the user X must not be interested in clicking on the advertisement of the general store situated in country B. The user X is in country A and the advertisement is of the general store situated in country B. If the user X clicks on the advertisement of the general store situated in country B, location mismatch will occur. The advertisement fraud detection system 114 detects that the user X may be the bot or the automated machine based on location mismatch.

The advertisement fraud detection system 114 sends one or more notifications to alert the advertiser. The one or more notifications are sent to the advertiser with facilitation of one or more mediums. The one or more notifications are sent based on the one or more fraudulent actions performed using the one or more sources. The one or more mediums include but may not be limited to text message, email, voice notification, voice call, flash message, notification, mms and OTA messages.

In an example, the advertisement fraud detection system 114 alerts the advertiser by sending push notifications in case of the advertisement fraud being performed through the one or more sources. In another example, the advertisement fraud detection system 114 alerts the advertiser by sending emails in case of the advertisement fraud being performed by the one or more sources. In yet another example, the advertisement fraud detection system 114 sends flash or text messages to the advertiser upon detection of the advertisement fraud being performed by the one or more sources.

The interactive computing environment 100 includes the server 116. The server 116 stores one or more instructions to perform various operations of the advertisement fraud detection system 114. In an embodiment of the present disclosure, the server 116 is a cloud server which is built, hosted and delivered through a cloud computing platform. In general, cloud computing is a process of using remote network server which are hosted on the internet to store, manage, and process data. The use of cloud server helps the advertisement fraud detection system 114 to receive data from the media device 104 using the Internet.

In addition, the server 116 is associated with the database 116. The database 116 is storage location of all data associated with the advertisement fraud detection system 114. In an embodiment of the present disclosure, the advertisement fraud detection system 114 stores the device data, the traffic data and the third party data in the database 116. In another embodiment of the present disclosure, the database 116 provides storage location to the user data and the user action data.

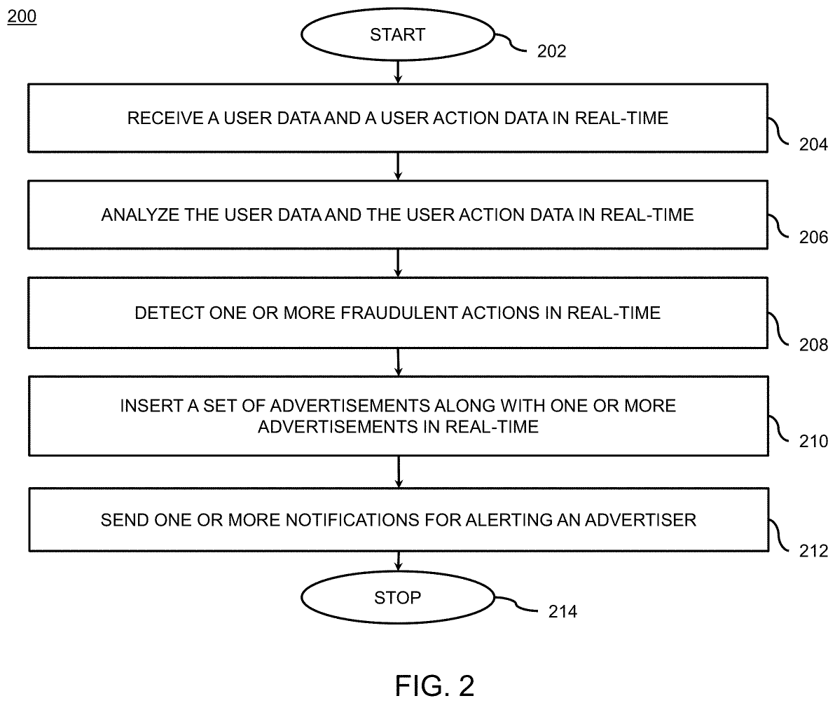

FIG. 2 illustrates a flow chart 200 of a method for the detection of fraud in the one or more advertisements, in accordance with various embodiments of the present disclosure. It may be noted that to explain the process steps of flowchart 200, references will be made to the system elements of FIG. 1. It may also be noted that the flowchart 200 may have fewer or more number of steps.

The flowchart 200 initiates at step 202. Following step 202, at step 204, the advertisement fraud detection system 114 receives the user data and a user action data in real-time. The advertisement fraud detection system 114 receives the user data and the user action data from the media device 104 associated with the user 102. At step 206, the advertisement fraud detection system 114 analyzes the user data and the user action data in real-time. The advertisement fraud detection system 114 analyzes the user data and the user action data to detect the potential advertisement fraud occurring using the one or more sources. At step 208, the advertisement fraud detection system 114 detects the one or more fraudulent actions in real-time. At step 210, the advertisement fraud detection system 114 inserts the set of advertisements along with the one or more advertisements 108 to confirm the advertisement fraud in real-time. The set of advertisements include at least one of the honeypot based advertisement campaign, the zero pixel advertisements, the blurred advertisements, the content based advertisements, the non-human clickable advertisements, and the like. The set of advertisements are fake advertisements inserted to attract the one or more sources to perform the advertisement fraud. At step 212, the advertisement fraud detection system 114 sends the one or more notifications to alert the advertiser. The one or more notifications are sent to the advertiser with facilitation of the one or more mediums. The one or more notifications are sent based on the one or more fraudulent actions performed using the one or more sources. The flow chart 200 terminates at step 214.

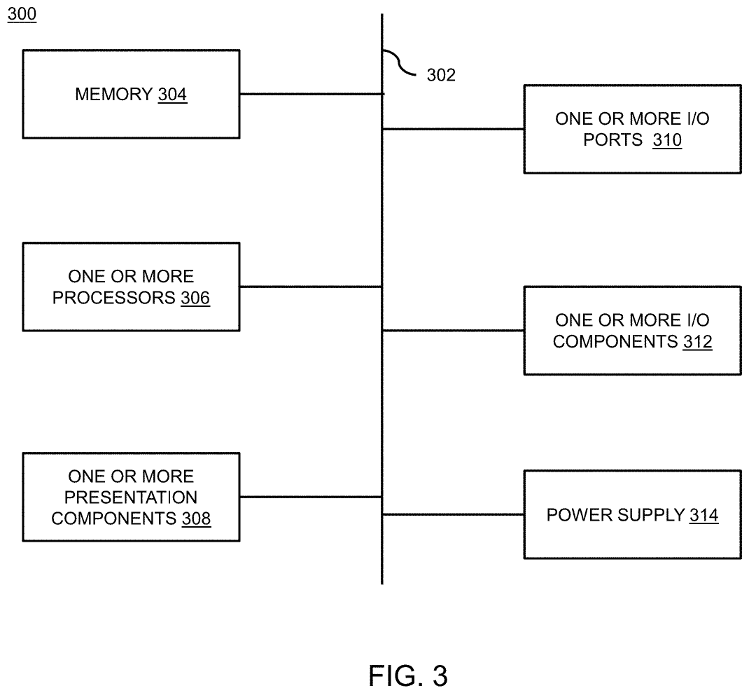

FIG. 3 illustrates a block diagram of a computing device 300, in accordance with various embodiments of the present disclosure. The computing device 300 is a non-transitory computer readable storage medium. The computing device 300 includes a bus 302 that directly or indirectly couples the following devices: memory 304, one or more processors 306, one or more presentation components 308, one or more input/output (I/O) ports 310, one or more input/output components 312, and an illustrative power supply 314. The bus 302 represents what may be one or more busses (such as an address bus, data bus, or combination thereof). Although the various blocks of FIG. 3 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 3 is merely illustrative of an exemplary computing device 300 that can be used in connection with one or more embodiments of the present invention. Distinction is not made between such categories as “workstation,” “server,” “laptop,” “hand-held device,” etc., as all are contemplated within the scope of FIG. 3 and reference to “computing device.”

The computing device 300 typically includes a variety of computer-readable media. The computer-readable media can be any available media that can be accessed by the device 300 and includes both volatile and nonvolatile media, removable and non-removable media. By way of example, and not limitation, the computer-readable media may comprise computer storage media and communication media. The computer storage media includes volatile and nonvolatile, removable and non-removable media implemented in any method or technology for storage of information such as computer-readable instructions, data structures, program modules or other data. The computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the device 300. The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 304 includes computer-storage media in the form of volatile and/or nonvolatile memory. The memory 304 may be removable, non-removable, or a combination thereof. Exemplary hardware devices include solid-state memory, hard drives, optical-disc drives, etc. The computing device 300 includes the one or more processors 306 that read data from various entities such as memory 304 or I/O components 312. The one or more presentation components 308 present data indications to the user or other device. Exemplary presentation components include a display device, speaker, printing component, vibrating component, etc. The one or more I/O ports 310 allow the computing device 300 to be logically coupled to other devices including the one or more I/O components 312, some of which may be built in. Illustrative components include a microphone, joystick, gamepad, satellite dish, scanner, printer, wireless device, etc.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

We claim:

1. A computer-implemented method for detecting advertisement fraud occurring using one or more sources in real-time, the computer-implemented method comprising:
receiving, at an advertisement fraud detection system with a processor, a user data and a user action data in real-time, wherein the user data and the user action data is received from a media device associated with a user, wherein the user data comprises data associated with demographic information of the user, wherein the user action data comprises data associated with actions performed by the user using the media device and interaction of the user with one or more advertisements;
analyzing, at the advertisement fraud detection system with the processor, the user data and the user action data in real-time, wherein the user data and the user action data is analyzed with facilitation of one or more hardware-run algorithms;
detecting, at the advertisement fraud detection system with the processor, one or more fraudulent actions in real-time, wherein the one or more fraudulent actions are detected based on deviation in the user data and the user action data from a predefined user data and a predefined user action data respectively;
inserting, at the advertisement fraud detection system with the processor, a set of advertisements along with the one or more advertisements in real-time, wherein the set of advertisements are fake advertisements inserted to attract the one or more sources performing the advertisement fraud, wherein the set of advertisements are inserted in one or more formats, wherein the set of advertisements are inserted for confirming the one or more fraudulent actions performed by the one or more sources for determining the advertisement fraud; and
sending, at the advertisement fraud detection system with the processor, one or more notifications for alerting an advertiser, wherein the one or more notifications are sent to the advertiser with facilitation of one or more mediums, wherein the one or more notifications are sent based on the one or more fraudulent actions performed using the one or more sources.

2. The computer-implemented method as recited in claim 1, wherein the user data comprising name, location, IP address, age, gender, culture, religion, marital status, nationality, education level and demographic information of the user, wherein the user action data comprising number of clicks, number of impressions, one or more transactions, one or more purchases, number of advertisements, and user behavior.

3. The computer-implemented method as recited in claim 1, wherein the one or more sources comprising at least one of malicious websites, an internet bot, web bot program, viruses, robots, and web crawlers.

4. The computer-implemented method as recited in claim 1, wherein the set of advertisements comprising honeypot based advertisement campaign, zero pixel advertisements, blurred advertisements, content based advertisements, and non-human clickable advertisements.

5. The computer-implemented method as recited in claim 1, wherein the one or more formats comprising at least one of display ads, social media ads, video ads, e-mail ads, text advertisement, audio advertisements, and graphical advertisements.

6. The computer-implemented method as recited in claim 1, wherein the one or more hardware-run algorithms comprising at least one of machine learning algorithms, artificial intelligence algorithms, neural network algorithms, and deep learning algorithms.

7. The computer-implemented method as recited in claim 1, wherein the one or more fraudulent actions comprising number of fraud clicks, fraudulent location, number of fake conversation, fraudulent behavior, fraudulent device, and fraudulent IP address.

8. The computer-implemented method as recited in claim 1, wherein the one or more mediums comprising text message, email, voice notification, voice call, flash message, notification, mms and OTA messages.

9. The computer-implemented method as recited in claim 1, further comprising mapping, at the advertisement fraud detection system with the processor, the user data with the predefined user data and the user action data with the predefined user action data, wherein the mapping is performed for detecting deviation in the user data from the predefined user data and deviation in the user action data from the predefined user action data, wherein the mapping is performed for detecting the advertisement fraud performed by a fraudulent publisher.

10. The computer-implemented method as recited in claim 1, further comprising blocking, at the advertisement fraud detection system with the processor, the one or more fraudsters, wherein the one or more fraudsters are blocked in real time, wherein the blocking of the one or more fraudsters is performed based on the one or more fraudulent actions.

11. A computer system comprising:
one or more processors; and
a memory coupled to the one or more processors, the memory for storing instructions which, when executed by the one or more processors, cause the one or more processors to perform a method for detecting advertisement fraud occurring using one or more sources in real-time, the method comprising:
receiving, at an advertisement fraud detection system, a user data, and a user action data in real-time, wherein the user data, and the user action data is received from a media device associated with a user, wherein the user data comprises data associated with demographic information of the user, wherein the user action data comprises data associated with actions performed by the user using the media device and interaction of the user with one or more advertisements;
analyzing, at the advertisement fraud detection system, the user data and the user action data in real-time, wherein the user data and the user action data is analyzed with facilitation of one or more hardware-run algorithms;
detecting, at the advertisement fraud detection system, one or more fraudulent actions in real-time, wherein the one or more fraudulent actions are detected based on deviation in the user data and the user action data from a predefined user data and a predefined user action data respectively;
inserting, at the advertisement fraud detection system, a set of advertisements along with the one or more advertisements in real-time, wherein the set of advertisements are fake advertisements inserted to attract the one or more sources performing the advertisement fraud, wherein the set of advertisements are inserted in one or more formats, wherein the set of advertisements are inserted for confirming the one or more fraudulent actions performed by the one or more sources for determining the advertisement fraud; and
sending, at the advertisement fraud detection system, one or more notifications for alerting an advertiser, wherein the one or more notifications are sent to the advertiser with facilitation of one or more mediums, wherein the one or more notifications are sent based on the one or more fraudulent actions performed using the one or more sources.

12. The computer system as recited in claim 11, wherein the user data comprising name, location, IP address, age, gender, culture, religion, marital status, nationality, education level and demographic information of the user, wherein the user action data comprising number of clicks, number of impressions, one or more transactions, one or more purchases, number of advertisements, and user behavior.

13. The computer system as recited in claim 11, wherein the one or more sources comprising at least one of malicious websites, an internet bot, web bot program, viruses, robots, and web crawlers.

14. The computer system as recited in claim 11, wherein the set of advertisements comprising honeypot based advertisement campaign, zero pixel advertisements, blurred advertisements, content based advertisements, and non-human clickable advertisements.

15. The computer system as recited in claim 11, wherein the one or more formats comprising at least one of display ads, social media ads, video ads, e-mail ads, text advertisement, audio advertisements, and graphical advertisements.

16. The computer system as recited in claim 11, wherein the one or more hardware-run algorithms comprising at least one of machine learning algorithms, artificial intelligence algorithms, neural network algorithms, and deep learning algorithms.

17. The computer system as recited in claim 11, wherein the one or more fraudulent actions comprising number of fraud clicks, fraudulent location, number of fake conversation, fraudulent behavior, fraudulent device, and fraudulent IP address.

18. The computer system as recited in claim 11, wherein the one or more mediums comprising text message, email, voice notification, voice call, flash message, notification, mms and OTA messages.

19. The computer system as recited in claim 11, further comprising mapping, at the advertisement fraud detection system, the user data with the predefined user data and the user action data with the predefined user action data, wherein the mapping is performed for detecting deviation in the user data from the predefined user data and deviation in the user action data from the predefined user action data, wherein the mapping is performed for detecting the advertisement fraud performed by a fraudulent publisher.

20. A non-transitory computer-readable storage medium encoding computer executable instructions that, when executed by at least one processor, performs a method for detecting advertisement fraud occurring using one or more sources in real-time, the computer-implemented method comprising:
receiving, at a computing device, a user data, and a user action data in real-time, wherein the user data, and the user action data is received from a media device associated with a user, wherein the user data comprises data associated with demographic information of the user, wherein the user action data comprises data associated with actions performed by the user using the media device and interaction of the user with one or more advertisements;
analyzing, at the computing device, the user data and the user action data in real-time, wherein the user data and the user action data is analyzed with facilitation of one or more hardware-run algorithms;
detecting, at the computing device, one or more fraudulent actions in real-time, wherein the one or more fraudulent actions are detected based on deviation in the user data and the user action data from a predefined user data and a predefined user action data respectively;
inserting, at the computing device, a set of advertisements along with the one or more advertisements in real-time, wherein the set of advertisements are fake advertisements inserted to attract the one or more sources performing the advertisement fraud, wherein the set of advertisements are inserted in one or more formats, wherein the set of advertisements are inserted for confirming the one or more fraudulent actions performed by the one or more sources for determining the advertisement fraud; and
sending, at the computing device, one or more notifications for alerting an advertiser, wherein the one or more notifications are sent to the advertiser with facilitation of one or more mediums, wherein the one or more notifications are sent based on the one or more fraudulent actions performed using the one or more sources.
